(19) United States
(12) Patent Application Publication
(10) Pub. No.: US 2024/0242105 A1
(43) Pub. Date: Jul. 18, 2024

(54) CALCULATION DEVICE, CALCULATION METHOD AND RECORDING MEDIUM

(71) Applicant: NEC Corporation, Minato-ku, Tokyo (JP)

(72) Inventor: Yuki SUSA, Tokyo (JP)

(73) Assignee: NEC Corporation, Minato-ku, Tokyo (JP)

(21) Appl. No.: 18/562,546

(22) PCT Filed: May 31, 2021
(86) PCT No.: PCT/JP2021/020729

§ 371 Date: Nov. 20, 2023

(51) Int. Cl. G06N 10/60; G06F 17/11

(52) U.S. Cl. CPC G06N 10/60; G06F 17/11

(57) ABSTRACT

A calculation device includes: a plurality of quantum nonlinear oscillators that change a quantum state from one quantum state to one of two quantum states, which differ from the one quantum state, or to a combined state of the two quantum states, according to a change in a control parameter value; a first coupler that couples the quantum nonlinear oscillators to one another at a coupling strength corresponding to a combinatorial optimization problem; a second coupler that couples the quantum nonlinear oscillators to one another separately from the first coupler; a controller that, in response to a passage of time, controls the control parameter value of the quantum nonlinear oscillators and the coupling strength between the quantum nonlinear oscillators by the second coupler; and a measurement device that measures the quantum state represented by the quantum nonlinear oscillators.

### TECHNICAL FIELD

The present invention relates to a calculation device, a calculation method, and a recording medium.

### BACKGROUND ART

Quantum annealing using quantum mechanical phenomena has been proposed as one method of solving combinatorial optimization problems.

For example, Patent Document 1 describes a quantum computation device that uses a Kerr parametric oscillator as a quantum nonlinear oscillator to execute quantum annealing.

### CITATION LIST

### Patent Document

Patent Document 1: Japanese Unexamined Patent Application, First Publication No. 2017-73106

### SUMMARY OF THE INVENTION

### Problems to be Solved by the Invention

When solving a combinatorial optimization problem by quantum annealing, it is preferable that the execution time of quantum annealing is as short as possible.

An exemplary object of the present invention is to provide a calculation device, a calculation method, and a recording medium that are capable of solving the problem described above.

### Means for Solving the Problem

According to a first exemplary aspect of the present invention, a calculation device includes: a plurality of quantum nonlinear oscillators that change a quantum state from one quantum state to one of two quantum states, which differ from the one quantum state, or to a combined state of the two quantum states, according to a change in a control parameter value; a first coupler that couples the quantum nonlinear oscillators to one another at a coupling strength corresponding to a combinatorial optimization problem; a second coupler that couples the quantum nonlinear oscillators to one another separately from the first coupler; a control means that, in response to a passage of time, controls the control parameter value of the quantum nonlinear oscillators and the coupling strength between the quantum nonlinear oscillators by the second coupler; and a measurement device that measures the quantum state represented by the quantum nonlinear oscillators.

According to a second exemplary aspect of the present invention, a calculation method executed by a computer that controls a calculation device in which a plurality of quantum nonlinear oscillators that change a quantum state from one quantum state to one of two quantum states, which differ from the one quantum state, or to a combined state of the two quantum states, according to a change in a control parameter value, are coupled to one another by a first coupler at a coupling strength corresponding to a combinatorial optimization problem, and the quantum nonlinear oscillators are further coupled to one another by a second coupler separately from the first coupler, includes: controlling, in response to a passage of time, the control parameter value of the quantum nonlinear oscillators and the coupling strength between the quantum nonlinear oscillators by the second coupler; and measuring the quantum state represented by the quantum nonlinear oscillators.

According to a third exemplary aspect of the present invention, a recording medium records a program for causing a computer that controls a calculation device in which a plurality of quantum nonlinear oscillators that change a quantum state from one quantum state to one of two quantum states, which differ from the one quantum state, or to a combined state of the two quantum states, according to a change in a control parameter value, are coupled to one another by a first coupler at a coupling strength corresponding to a combinatorial optimization problem, and the quantum nonlinear oscillators are further coupled to one another by a second coupler separately from the first coupler, to execute: controlling, in response to a passage of time, the control parameter value of the quantum nonlinear oscillators and the coupling strength between the quantum nonlinear oscillators by the second coupler; and measuring the quantum state represented by the quantum nonlinear oscillators.

### Effect of Invention

According to the present invention, it is possible to shorten the execution time of quantum annealing.

### BRIEF DESCRIPTION OF THE DRAWINGS

FIG. 1 is a diagram showing a configuration example of a calculation device according to an exemplary embodiment.

FIG. 2 is a diagram showing a first example of time evolution of a quantum state according to an exemplary embodiment.

FIG. 3 is a diagram showing a second example of time evolution of a quantum state according to an exemplary embodiment.

FIG. 4 is a diagram showing a third example of time evolution of a quantum state according to an exemplary embodiment.

FIG. 5 is a diagram showing an example of a function A(s) according to an exemplary embodiment.

FIG. 6 is a diagram showing an example of a function B(s) according to an exemplary embodiment.

FIG. 7 is a diagram showing a first example of the relationship between the value of a control parameter s and the value of a magnetization m according to an exemplary embodiment.

FIG. 8 is a diagram showing a second example of the relationship between the value of a control parameter s and the value of a magnetization m according to an exemplary embodiment.

FIG. 9 is a diagram showing a third example of the relationship between the value of a control parameter s and the value of a magnetization m according to an exemplary embodiment.

FIG. 10 is a diagram showing an example of the relationship between the coupling strength by second couplers and the discontinuous change width of a magnetization m according to an exemplary embodiment.

FIG. 11 is a phase diagram illustrated based on the computation result of a magnetization m using expression (15) according to an exemplary embodiment.

FIG. 12 is a flowchart showing an example of a processing procedure when a combinatorial optimization problem is solved using a calculation device 100 according to an exemplary embodiment.

FIG. 13 is a diagram showing a second example of a configuration of a calculation device according to an exemplary embodiment.

FIG. 14 is a diagram showing an example of a processing procedure of a calculation method according to an exemplary embodiment.

FIG. 15 is a schematic block diagram showing a configuration of a computer according to at least one exemplary embodiment.

### EXAMPLE EMBODIMENT

Hereunder, exemplary embodiments of the present embodiment will be described. However, the following exemplary embodiments does not limit the invention according to the claims. Furthermore, all combinations of features described in the exemplary embodiments may not be essential to the solution means of the invention.

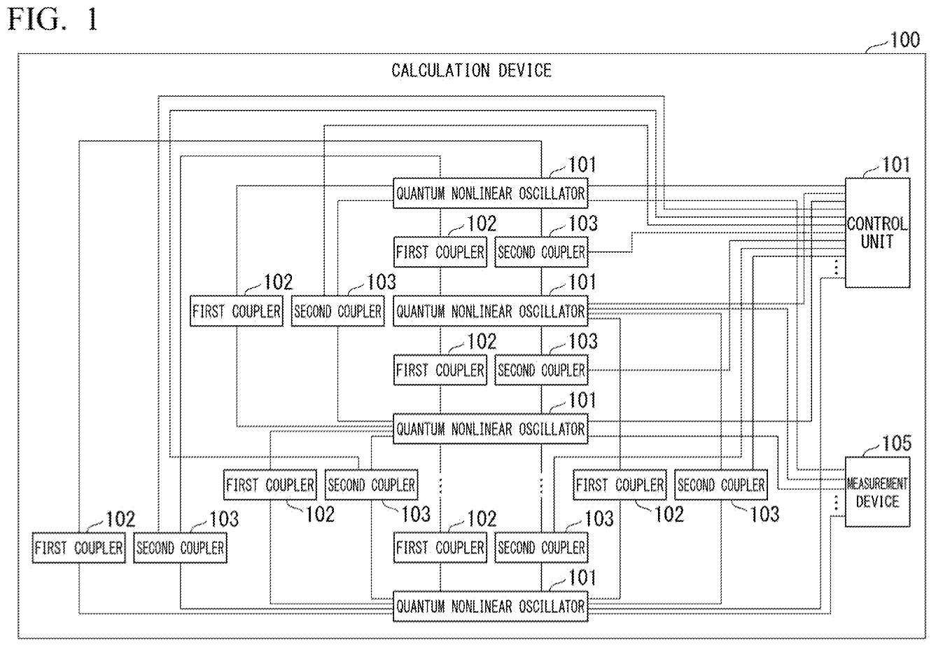

FIG. 1 is a diagram showing a configuration example of a calculation device according to an exemplary embodiment. In the configuration shown in FIG. 1, a calculation device 100 includes quantum nonlinear oscillators 101, first couplers 102, second couplers 103, a control unit 104, and a measurement device 105.

The calculation device 100 executes quantum annealing. Quantum annealing is also simply referred to as annealing.

Quantum annealing is a method of solving a combinatorial problem using quantum mechanical phenomena. A combinatorial problem is a problem of maximizing or minimizing the value of an evaluation function (objective function) with a large number of variables, or searching for a set of variable values that satisfy a decision condition that ends the operation of solving the problem. It is known that, as the number of variables increases, the number of combinatorial patterns increases exponentially, making it very difficult to search for a solution. Hereunder, for convenience of explanation, a combinatorial problem will be referred to as an “optimization problem”, and a solution of a combinatorial problem will be referred to as an “optimal solution”. Moreover, the optimization problem is assumed to be a problem of searching for a set of variable values that minimizes the value of an evaluation function.

In quantum annealing, by expressing the evaluation function with a Hamiltonian of an Ising model, which is a function of the variables representing a quantum state, the optimal solution of a combinatorial optimization problem can be found as the ground state of the Ising model. The ground state of the Ising model represents the state in which the energy is minimized. That is to say, quantum annealing searches for the ground state of the Ising model.

The variables representing a quantum state in the Ising model are also referred to as Ising variables.

The Ising model is a model whose Hamiltonian is represented by the following expression (1).

$$\begin{matrix}[ Expression 1 ] & \\ {H}_{Ising} = - {\sum }_{i = 1}^{N} {h}_{i} {σ}_{i} - {\sum }_{i < j} {J}_{ij} {σ}_{i} {σ}_{j} & ( 1 )\end{matrix}$$

Here, σᵢ and σⱼ are Ising variables that each take values of +1 or −1. Further, the Ising variables may take an initial value of 0 depending on the execution method of quantum annealing. When the calculation device 100 executes quantum annealing using the Hamiltonian shown in expression (1) as the evaluation function, the Ising variables σᵢ and σⱼ each take an initial value of 0.

In expression (1), i and j are indexes of the Ising variables. The indexes i and j identify the Ising variables. The term hᵢ in Σᵢ₌₁^{N} (hᵢσᵢ), which is the first term on the right side of expression (1), represents a local bias and takes a real value. Jᵢⱼ in Σ_{i<j} (Jᵢⱼσᵢσⱼ), which is the second term on the right side of expression (1), is a coupling constant representing the strength of the correlation between σᵢ and σⱼ, and takes a real value. When Jᵢⱼ takes a positive value, the strength of the positive correlation increases as the magnitude of Jᵢⱼ (absolute value |Jᵢⱼ|) increases. When Jᵢⱼ takes a negative value, the strength of the negative correlation increases as the magnitude of Jᵢⱼ increases.

The conversion of a combinatorial optimization problem to an Ising model corresponds to setting the values of hᵢ and Jᵢⱼ in expression (1). In quantum annealing, the Hamiltonian of the Ising model shown in expression (1) may be used as an evaluation function to search for a combination of ±1 values of the Ising variables that minimizes the value of the evaluation function. N is a positive integer representing the problem size of the combinatorial optimization problem. Expression (1) includes N Ising variables from σ₁ to σ_{N}.

The evaluation function represented by expression (1) expresses a combinatorial optimization problem when at most two Ising variables are correlated. However, the number of Ising variables used in a combinatorial optimization problem may be one or more, and is not limited to a specific number. Depending on the combinatorial optimization problem, three Ising variables may be correlated. In this case, a term represented by the product of the three Ising variables, such as σᵢσⱼσₖ, is added to expression (1). Likewise, in the case of a combinatorial optimization problem in which four or more Ising variables are correlated, a term represented by the product of the correlated Ising variables is added to expression (1).

As methods of executing quantum annealing, a method using quantum fluctuations and a method using a quantum mechanical bifurcation phenomenon have been proposed. These are fundamentally different methods.

In quantum annealing using quantum fluctuations, the intensity of a quantum fluctuation is used as a control parameter. First, a superposition state is realized by applying strong quantum fluctuations to all qubits. Next, in the process of reducing the intensity of the quantum fluctuations, the interaction between qubits determined based on the combinatorial optimization problem is strengthened. Then, the solution of the combinatorial optimization problem is obtained by reading the value of the Ising variables from the quantum state of the qubits when the intensity of the quantum fluctuations becomes 0.

The calculation device 100 performs quantum annealing using a quantum mechanical bifurcation phenomenon.

Quantum annealing using a quantum mechanical bifurcation phenomenon uses quantum nonlinear oscillators. Quantum annealing using a quantum mechanical bifurcation phenomenon can use a dimensionless control parameter that evolves over time.

In a quantum nonlinear oscillator, the quantum state changes adiabatically in response to a change in a control parameter value. Specifically, a quantum nonlinear oscillator is capable of creating a superposition state of two distinguishable quantum states by bifurcation of a quantum state set as an initial state. Each of the two distinguishable quantum states after bifurcation can be associated with the values of the Ising variables.

The adiabatic change referred to here may be a quasi-static change without interference from the outside world.

Changing a quantum state adiabatically in response to a change in a control parameter value is also referred to as adiabatically controlling a control parameter.

In quantum annealing using a quantum mechanical bifurcation phenomenon, quantum nonlinear oscillators are coupled at a strength determined based on a combinatorial optimization problem. In addition, a solution to the combinatorial optimization problem can be obtained by changing a control parameter value such that the quantum state of the quantum nonlinear oscillators undergoes bifurcation into one of two quantum states.

For example, when the calculation device 100 solves a combinatorial optimization problem, the first couplers 102 couple the plurality of quantum nonlinear oscillators 101 to one another at a strength determined based on the combinatorial optimization problem. In addition to the first couplers 102, the second couplers 103 couple the plurality of quantum nonlinear oscillators 101 to one another in order to eliminate or reduce a first-order phase transition.

Further, the control unit 104 controls the control parameter. The quantum state of each quantum nonlinear oscillator 101 changes to one of two distinguishable quantum states in response to a change in the control parameter value. As a result of the measurement device 105 measuring the quantum state of each quantum nonlinear oscillator 101, the solution of the combinatorial optimization problem represented by the values of the Ising variables, which correspond to each state, is obtained.

The control unit 104 corresponds to an example of a control means.

The configuration of the control unit 104 is not limited to a specific configuration. For example, the control unit 104 may be configured using a computer. Alternatively, the control unit 104 may be configured using programmable hardware such as an ASIC (Application Specific Integrated Circuit) or an FPGA (Field Programmable Gate Array).

In both a method using quantum fluctuation and a method using a quantum mechanical bifurcation phenomenon, it is known that, in order to obtain the optimal solution of a combinatorial optimization problem by quantum annealing, it is generally necessary to ensure a time for completion of annealing that is long enough to enable adiabatic control.

The time required for annealing can be estimated by the quantum adiabatic theorem. Some combinatorial optimization problems are difficult problems that take a very long time to solve even with quantum annealing. For example, in optimization problems in which a first-order phase transition occurs during the quantum annealing process, it is known that the quantum annealing time required to obtain the optimal solution increases exponentially with the problem size.

In quantum annealing using a quantum mechanical bifurcation phenomenon, a quantum nonlinear oscillator generates one of two distinguishable quantum states corresponding to ±1 of the Ising variable as a result of adiabatically controlling the control parameter.

Here, generating a state may refer to setting a state to a certain state. For example, generating a state may refer to changing a state to a state that is different from the original state. Alternatively, generating a state may refer to changing a state to the same state as the original state, or to a state that is different from the original state.

Here, the fact that the two quantum states are distinguishable means that when the quantum state is measured, one of the two quantum states is obtained as the measurement result, and a superposition state of the two quantum states is not obtained as the measurement result. On the other hand, generating two quantum states that are distinguishable may refer to setting the state to one of the two quantum states, or to a superposition state of the two quantum states. Even when the quantum state is in a superposition state of the two quantum states, one of the two quantum states is obtained as the measurement result of the quantum state, and the superposition state of the two quantum states is not obtained as the measurement result of the quantum state.

In quantum annealing using a quantum mechanical bifurcation phenomenon, the calculation device reads the quantum state generated by each quantum nonlinear oscillator, inputs the value of the corresponding Ising variable to an evaluation function, and searches for a solution of the combinatorial optimization problem. As the evaluation function, for example, a Hamiltonian of the Ising model represented by the expression (1) above can be used.

Hereunder, quantum annealing using a quantum mechanical bifurcation phenomenon will be described, taking as an example a case where an oscillator expressed using a spin matrix is used as the quantum nonlinear oscillators.

However, the quantum nonlinear oscillator 101 is not limited to an oscillator expressed using a spin matrix, and can be various quantum nonlinear oscillators exhibiting a quantum mechanical bifurcation phenomenon. For example, a Kerr parametric oscillator may be used as the quantum nonlinear oscillator 101.

The quantum state generated by a single quantum nonlinear oscillator is given, for example, as an instantaneous ground state for each value of a control parameter s according to the Hamiltonian H(s) shown in expression (2) below.

$$\begin{matrix}[ Expression 2 ] & \\ H ( s ) = - A ( s ) {S}^{x} - B ( s ) {( {S}^{z} )}^{2} - h {S}^{z} & ( 2 )\end{matrix}$$

The Hamiltonian H(s) shown in expression (2) is for expressing the operation of the quantum nonlinear oscillator. The Hamiltonian H(s) shown in expression (2) is different from the Hamiltonian H_{Ising} for expressing the combinatorial optimization problem shown in expression (1).

The x-direction component S^{x} of a spin matrix operator with a spin number of 1 is expressed as in expression (3).

$$\begin{matrix}[ Expression 3 ] & \\ {S}^{x} = \frac{1}{\sqrt{2}} ( \begin{matrix}0 & 1 & 0 \\ 1 & 0 & 1 \\ 0 & 1 & 0\end{matrix} ) & ( 3 )\end{matrix}$$

The z-direction component S^{z} of the spin matrix operator with a spin number of 1 is expressed as in expression (4).

$$\begin{matrix}[ Expression 4 ] & \\ {S}^{z} = ( \begin{matrix}1 & 0 & 0 \\ 0 & 0 & 0 \\ 0 & 0 & - 1\end{matrix} ) & ( 3 )\end{matrix}$$

s is the control parameter of the quantum nonlinear oscillator, and is a continuously increasing function of time. At the start of annealing, s=0. At the end of annealing, s=1.

A(s) is a continuous function of s, and outputs a non-negative scalar value for any s in the range 0≤ s≤1.

B(s) is a continuous function of s, and outputs a negative scalar value at s=0 and a positive scalar value at s=1. It is assumed that |B(s)| is sufficiently larger than |A(s)| for both s=0 and s=1. For example, |B(s)| may take a value that is approximately 10 times larger than |A(s)| for both s=0 and s=1.

It is assumed that the value of s in which B(s)=0 is unique. It is assumed that |A(s)| takes a value that is sufficiently larger than 0 for the value of s in which B(s)=0.

A(s) can be any function that satisfies the above conditions. For example, A(s) may be a constant function, a Gaussian function, a trigonometric function whose half period is the interval [0, 1] of s, or a triangular function. However, the function is not limited to these.

B(s) can be any function that satisfies the above conditions. For example, B(s) may be a linear function, a quadratic function, a hyperbolic tangent function, an error function, or a Softsign function. However, the function is not limited to these.

A(s) may be a different function for each quantum nonlinear oscillator. B(s) may also be a different function for each quantum nonlinear oscillator. In the following, for convenience of explanation, it is assumed that the same function is used for A(s) in all of the quantum nonlinear oscillators. It is also assumed that the same function is used for B(s) in all of the quantum nonlinear oscillators.

In expression (2), by adiabatically controlling the control parameter s to continuously increase from 0 to 1, the quantum nonlinear oscillators generate two distinguishable quantum states that are different from the initial quantum state at s=0.

In expression (2), h in the third term “−hS^{z}” on the right side is a constant representing a local bias.

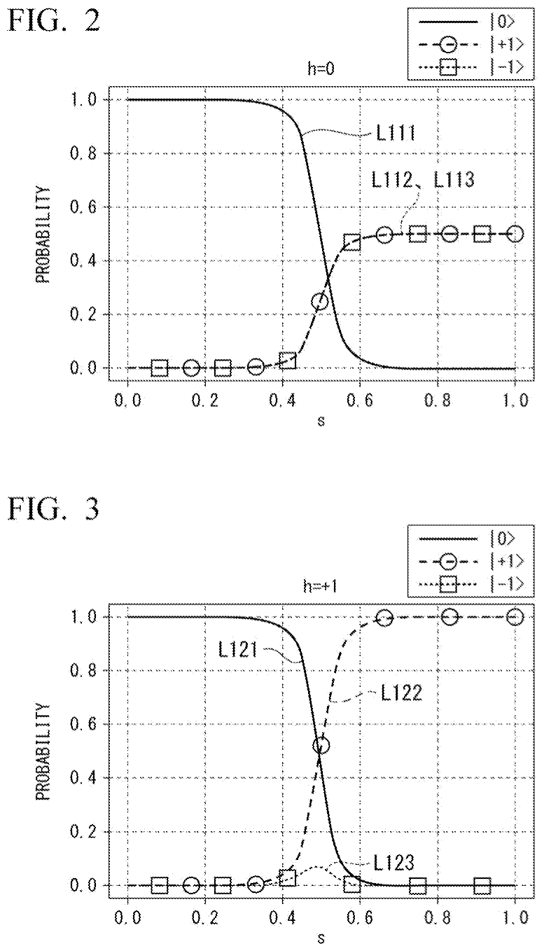

FIG. 2 is a diagram showing a first example of time evolution of a quantum state. FIG. 2 shows a first example in which the quantum nonlinear oscillator generates, from an initial quantum state “|0>”, a quantum state “|+1>” corresponding to an Ising variable of +1, or a quantum state “|−1>” corresponding to an Ising variable of −1, in response to a continuous increase of the value of the control parameter s from 0 to 1 in expression (2). The horizontal axis of the graph in FIG. 2 represents the value of the control parameter s, and the vertical axis represents the probability that each of the quantum state “|0>”, the quantum state “|+1>”, and the quantum state “|−1>” are measured according to the value of s.

The line L111 represents the probability that the quantum state “|0>” is measured. The line L112 represents the probability that the quantum state “|+1>” is measured. The line L113 represents the probability that the quantum state “|−1>” is measured. In FIG. 2, the line L112 and the line L113 overlap.

The quantum state generated at the completion of annealing depends on the value of h in the third term in expression (2). FIG. 2 shows an example where h=0.

The three quantum states “|0>”, “|+1>” and “|−1>” that can be generated by the quantum nonlinear oscillator are all eigenstates represented by the matrix operator Sᵢ^{z} in expression (4), and have the eigenvalues 0, +1, and −1, respectively.

In the example of FIG. 2, both the quantum state “|+1>” and the quantum state “|−1>” are measured with a probability of 0.5 at the completion of annealing when s=1.0. This indicates that a superposition state of two quantum states (|+1>, |−1>) is generated. In this way, when h is 0, a superposition state of two quantum states (|+1>, |−1>) is generated at the completion of annealing.

In the example of FIG. 2, near s=0.5, the probability of measuring the initial quantum state “|0>” decreases, and the probability of measuring the quantum state “|+1>” and the probability of measuring the quantum state “|−1>” increases. This indicates that a quantum bifurcation phenomenon is occurring.

FIG. 3 is a diagram showing a second example of time evolution of a quantum state. FIG. 3 shows a second example in which the quantum nonlinear oscillator generates, from an initial quantum state “|0>”, a quantum state “|+1>” corresponding to an Ising variable of +1, or a quantum state “|−1>” corresponding to an Ising variable of −1, in response to a continuous increase of the value of the control parameter s from 0 to +1 in Expression (2). The horizontal axis of the graph in FIG. 3 represents the value of the control parameter s, and the vertical axis represents the probability that, among the quantum states, each of “|0>”, “|+1>”, and “|−1>” are measured according to the value of s.

The line L121 represents the probability that the quantum state “|0>” is measured. The line L122 represents the probability that the quantum state “|+1>” is measured. The line L123 represents the probability that the quantum state “|−1>” is measured.

FIG. 3 shows an example where h=1. In the example of FIG. 3, only the quantum state “|+1>” is measured at the completion of annealing when s=1.0. In this way, when h is a positive value, only the quantum state “|+1>” is measured at the completion of annealing.

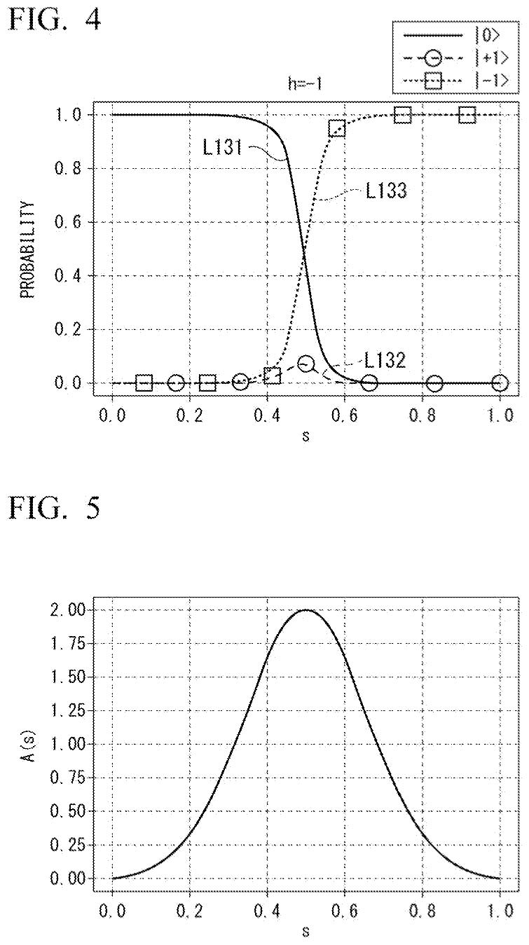

FIG. 4 is a diagram showing a third example of time evolution of a quantum state. FIG. 4 shows a third example in which the quantum nonlinear oscillator generates, from an initial quantum state “|0>”, a quantum state “|+1>” corresponding to an Ising variable of +1, or a quantum state “|−1>” corresponding to an Ising variable of −1, in response to a continuous increase of the value of the control parameter s from 0 to +1 in expression (2). The horizontal axis of the graph in FIG. 4 represents the value of the control parameter s, and the vertical axis represents the probability that each of the quantum state “|0>”, the quantum state “|+1>”, and the quantum state “|−1>” are measured according to the value of s.

The line L131 represents the probability that the quantum state “|0>” is measured. The line L132 represents the probability that the quantum state “|+1>” is measured. The line L133 represents the probability that the quantum state “|−1>” is measured.

FIG. 4 shows an example where h=−1. In the example of FIG. 4, only the quantum state “|−1>” is measured at the completion of annealing when s=1.0. In this way, when h is a negative value, only the quantum state “|−1>” is measured at the completion of annealing.

FIG. 5 is a diagram showing an example of the function A(s). FIG. 5 shows an example of using a Gaussian function as the function A(s). In the examples from FIG. 2 to FIG. 4, the function A(s) in expression (2) is a Gaussian function such as that shown in FIG. 5.

However, the function A(s) is not limited to a Gaussian function. As mentioned above, a function that takes s as an argument and outputs a non-negative scalar value can be used as the function A(s).

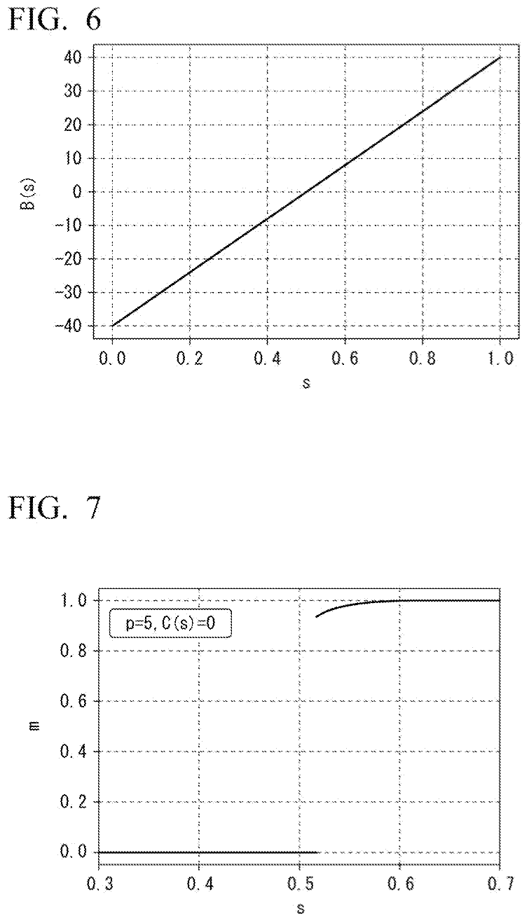

FIG. 6 is a diagram showing an example of the function B(s). FIG. 6 shows an example of using a linear function as the function B(s). In the examples from FIG. 2 to FIG. 4, the function B(s) in expression (2) is a linear function such as that shown in FIG. 6.

However, the function B(s) is not limited to a linear function. As mentioned above, as the function B(s), it is possible to use a function that outputs a negative scalar value at s=0, outputs a positive scalar value at s=1, and takes a value at s=1 such that B(s) is greater than A(s).

The quantum state generated by N quantum nonlinear oscillators that interact with one another is given, for example, as an instantaneous ground state for each value of the control parameter s according to the Hamiltonian H shown in expression (5) below.

$$\begin{matrix}[ Expression 5 ] & \\ H ( s ) = {\sum }_{i = 1}^{N} ( - A ( s ) {S}_{i}^{x} - B ( s ) {( {S}_{i}^{z} )}^{2} - {h}_{i} {S}_{i}^{z} ) {\sum }_{i < j} {J}_{ij} {S}_{i}^{z} {S}_{j}^{z} & ( 5 )\end{matrix}$$

In expression (5), i and j are indexes of the quantum nonlinear oscillators. The indexes i and j identify the quantum nonlinear oscillators. “−A(s)Six” in the first term and “−B(s)(Sᵢ^{z})²” in the second term on the right side of expression (5) correspond to “−A(s)S^{x}” in the first term and “−B(s)(S^{z})²” in the second term on the right side of expression (2), respectively. hᵢ in the third term on the right side of expression (5) represents the local bias. “−A(s)S^{x}-B(s)(S^{z})²-hᵢSᵢ^{z}” in expression (5) represents the quantum state of each quantum nonlinear oscillator.

Jᵢⱼ in the fourth term on the right side of expression (5) represents the coupling strength between two quantum nonlinear oscillators. “JᵢⱼSᵢ^{z}Sⱼ^{z}” in expression (5) represents the interaction between the quantum nonlinear oscillators.

The terms hᵢ and Jᵢⱼ in expression (5) are the same as the terms hᵢ and Jᵢⱼ shown in expression (1). The value of hᵢ and the value of Jᵢⱼ are each set according to the combinatorial optimization problem.

In the Hamiltonian shown in expression (5), when the control parameter s is 0, each quantum nonlinear oscillator generates the initial quantum state “|0>”. By adiabatically controlling the control parameter s to continuously increase from 0 to 1, each quantum nonlinear oscillator generates an instantaneous ground state in the Hamiltonian in expression (5) that changes from moment to moment. When s=1, each quantum nonlinear oscillator has a quantum state (“|+1>” or “|−1>”) corresponding to a combination of Ising variable values that minimizes the value of the evaluation function shown in expression (1). Then, by measuring the quantum state generated by each quantum nonlinear oscillator, the combination of Ising variable values that minimizes the value of the evaluation function is obtained.

Expression (5) shows a Hamiltonian for a case where two quantum nonlinear oscillators are coupled. When solving a combinatorial optimization problem in which three Ising variables are correlated, a term represented by a product of three spin matrices, such as Sᵢ^{z}Sⱼ^{z}Sₖ^{z}, is added to the Hamiltonian in expression (5), and the combination can be determined by coupling the three quantum nonlinear oscillators. Similarly, when solving a combinatorial optimization problem in which four or more Ising variables are correlated, a term represented by a product of the number of spin matrices equivalent to the number of correlated Ising variables is added to the Hamiltonian in expression (5), and the combination can be determined by coupling the number of quantum nonlinear oscillators equivalent to the number of correlated Ising variables.

When the energy levels of the quantum system are traced in chronological order in the Hamiltonian shown in expression (5), there is a moment when the energy levels of the ground state and an excited state are closest to each other. The energy difference between the ground state and the excited state at this moment is sometimes referred to as the minimum energy gap. It is known that expression (6) holds when the time required to obtain the optimal solution by quantum annealing, that is to say, the time to be taken to change the value of the control parameter from 0 to 1, is T, and the minimum energy gap is Δ.

$$\begin{matrix}[ Expression 6 ] & \\ T ∝ {Δ}^{- 2} & ( 6 )\end{matrix}$$

Expression (6) shows that the time T required to obtain the optimal solution by quantum annealing is proportional to the reciprocal of the square of the minimum energy gap Δ. According to expression (6), the time required for quantum annealing increases as the minimum energy gap decreases. In other words, when the quantum annealing time T is fixed, the probability of obtaining the optimal solution decreases as the minimum energy gap decreases.

In the case of a combinatorial optimization problem in which a first-order phase transition phenomenon occurs during annealing, it is generally known that the minimum energy gap decreases exponentially as the size of the problem increases. That is to say, in the case of a combinatorial optimization problem in which a first-order phase transition phenomenon occurs during annealing, the time T required to obtain the optimal solution by quantum annealing increases exponentially.

Furthermore, in the case of a combinatorial optimization problem in which a second-order phase transition phenomenon occurs, it is known that the minimum energy gap decreases according to a power function as the size of the problem increases. Therefore, in the case of a combinatorial optimization problem in which a second-order phase transition phenomenon occurs, the time T required to obtain the optimal solution by quantum annealing increases according to a power function.

It is easier to find the optimal solution for a combinatorial optimization problem in which the time required to find the optimal solution increases according to a power function as the problem size increases, than for a combinatorial optimization problem in which the time required increases exponentially. In particular, it is expected that the time T required to obtain the optimal solution by quantum annealing is shorter for a combinatorial optimization problem in which a second-order phase transition phenomenon occurs than for a combinatorial optimization problem in which a first-order phase transition phenomenon occurs.

As described above, in quantum annealing using a quantum mechanical bifurcation phenomenon, a combination of the values −1 or 1 of the Ising variables that minimize the evaluation function described by the Hamiltonian of an Ising model is determined from the quantum state generated by the quantum nonlinear oscillators. The size of the minimum energy gap is related to the difficulty of the combinatorial optimization problem. There is generally no problem in thinking that the minimum energy gap decreases as the difficulty of the combinatorial optimization problem increases. Further, it is generally known that the minimum energy gap decreases as the problem size increases. Moreover, in the case of a combinatorial optimization problem in which a first-order phase transition phenomenon occurs during annealing, it is difficult to find a solution even with quantum annealing.

Each of the quantum nonlinear oscillators 101 of the calculation device 100 causes the quantum state in the Ising model to evolve over time. As described above, the quantum nonlinear oscillators 101 change from the quantum state “|0>” to the quantum state “|+1>” or the quantum state “|−1>”, or a superposition state of the quantum states “|+1>” and “|−1>” in response to an increase in the value of the control parameter s.

The quantum nonlinear oscillators 101 can be configured using an existing quantum oscillator having nonlinearity, such as a Kerr parametric oscillator.

Each of the plurality of first couplers 102 and the second couplers 103 couple the plurality of quantum nonlinear oscillators 101 to one another at a variable coupling strength. As described above, the first couplers 102 couple the quantum nonlinear oscillators 101 to one another at a strength determined based on the combinatorial optimization problem. The second couplers 103 couple the quantum nonlinear oscillators 101 to one another to eliminate or reduce a first-order phase transition.

Both the first couplers 102 and the second couplers 103 can be configured using programmable couplers used for quantum annealing.

As described above, the calculation device 100 is a device that finds the optimal solution of a combinatorial optimization problem by quantum annealing using a quantum mechanical bifurcation phenomenon. The combinatorial optimization problem is converted into an evaluation function described by an Ising model as shown in expression (1), and the calculation device 100 finds the optimal solution by determining the ground state.

Each of the N quantum nonlinear oscillators 101 operates according to the Hamiltonian H_{QNO}(s) shown as expression (7).

$$\begin{matrix}[ Expression 7 ] & \\ {H}_{QN 0} ( s ) : = {\sum }_{i = 1}^{N} ( - A ( s ) {S}_{i}^{x} - B ( s ) {( {S}_{i}^{z} )}^{2} - {h}_{i} {S}_{i}^{z} ) & ( 7 )\end{matrix}$$

In expression (7), i is an index of each quantum nonlinear oscillator 101. The index i identifies the quantum nonlinear oscillators 101. N is the problem size of the combinatorial optimization problem. The number of quantum nonlinear oscillators 101 used for annealing is N. Each quantum nonlinear oscillator 101 can generate two distinguishable quantum states at the completion of annealing.

“Σᵢ₌₁^{N} (−A(s)Sᵢ^{x}-B(s)(Sᵢ^{z})²-hᵢSᵢ^{z})” on the right side of expression (7) is equivalent to “Σᵢ₌₁^{N} (−A(s)Sᵢ^{x}-B(s)(Sᵢ^{z})²-hᵢSᵢ^{z})” on the right side of expression (5).

A(s) in the first term on the right side of expression (7) is a function that outputs a non-negative scalar value. A(s) can be, for example, a constant or a Gaussian function, but is not limited to this. The second term B(s) on the right side of expression (7) is a function that outputs a negative scalar value when s=0 and a positive scalar value when s=1.

The value of hᵢ in the third term on the right side of expression (7) represents the strength of the local bias of each quantum nonlinear oscillator 101, which is set according to the combinatorial optimization problem to be solved.

The quantum nonlinear oscillators 101 can be coupled to one another via the first couplers 102. The Hamiltonian representing the coupling by the first couplers 102 is expressed as in expression (8).

$$\begin{matrix}[ Expression 8 ] & \\ {H}_{i} = - {\sum }_{i < j} {J}_{ij} {S}_{i}^{z} {S}_{j}^{z} & ( 8 )\end{matrix}$$

“−Σ_{i<j} JᵢⱼSᵢ^{z}Sⱼ^{z}” on the right side of expression (8) is equivalent to“−Σ_{i<j} JᵢⱼSᵢ^{z}Sⱼ^{z}” on the right side of expression (5).

Jᵢⱼ represents the strength of the coupling between the quantum nonlinear oscillators 101 by the first couplers 102, which is set according to the combinatorial optimization problem to be solved. In expression (8), i and j are indexes of the quantum nonlinear oscillators 101. The indexes i and j identify the quantum nonlinear oscillators 101.

Expression (8) shows a Hamiltonian for a case where two quantum nonlinear oscillators 101 are coupled via the first couplers 102. When solving a combinatorial optimization problem in which three Ising variables are correlated, a term represented by a product of three spin matrices, such as Sᵢ^{z}Sⱼ^{z}Sₖ², is added to the Hamiltonian in expression (8), and the combination can be determined by coupling the three quantum nonlinear oscillators. Similarly, when solving a combinatorial optimization problem in which four or more Ising variables are correlated, a term represented by a product of the number of spin matrices equivalent to the number of correlated Ising variables is added to the Hamiltonian in expression (8), and the combination can be determined by coupling the number of quantum nonlinear oscillators 101 equivalent to the number of correlated Ising variables.

The quantum nonlinear oscillators 101 can be coupled to one another via the second couplers 103. The Hamiltonian representing the coupling by the second couplers 103 is expressed as in expression (9).

$$\begin{matrix}[ Expression 9 ] & \\ {H}_{int 2} ( s ) : = C ( s ) {\sum }_{i < j} {X}_{i} {X}_{j} & ( 9 )\end{matrix}$$

In expression (9), i and j are indexes of the quantum nonlinear oscillators 101. The indexes i and j identify the quantum nonlinear oscillators 101. Xᵢ, Xⱼ are matrix operators. In expression (9), “XᵢXⱼ” represents the tensor product of Xᵢ and Xⱼ.

C(s) is a function that takes a non-negative value with s as an argument, and represents the strength of coupling between the quantum nonlinear oscillators 101 to one another by the second couplers 103. C(s) may be a different function for each combination of (i, j). In the following, for convenience of explanation, it is assumed that C(s) is the same function regardless of the combination of (i, j).

Both Xᵢ and Xⱼ are defined as X in Expression (10).

$$\begin{matrix}[ Expression 10 ] & \\ X := \vert + 1 〉 〈 - 1 \vert + \vert - 1 〉 〈 + 1 \vert = ( \begin{matrix}0 & 0 & 1 \\ 0 & 0 & 0 \\ 1 & 0 & 0\end{matrix} ) & ( 10 )\end{matrix}$$

In “|+1><−1|” of expression (10), the quantum state “|+1>” is represented by a column vector, and the quantum state “<−1|” is represented by a row vector. In “|−1><+1|”, the quantum state “|−1>” is represented by a column vector, and the quantum state “<+1|” is represented by a row vector. Each of the vector products “|+1><−1|” and “|−1><+1|” constitutes a matrix of 3 rows and 3 columns, and these matrices are added to obtain the matrix on the right side. “[+]><−1\” yields the lower-left element value “1” of the matrix on the right side. “|−1><+1|” yields the upper-right element value “1” of the matrix on the right side.

When the operation represented by the matrix operator X in expression (10) is applied to the two distinguishable quantum states (|+1>, |−1>) generated by the quantum nonlinear oscillator 101, the effect of changing one quantum state to the other state is obtained.

The coupling by the second couplers 103 can be described as an antiferromagnetic interaction of an operator that, like the Hamiltonian shown in expression (9), expresses a conversion of one of two distinguishable quantum states generated by the quantum nonlinear oscillator 101 into the other quantum state.

As described above, the Hamiltonian Hᵢₙₜ₂(s) in expression (9) is the Hamiltonian when two quantum nonlinear oscillators 101 are coupled via the second couplers 103. When three quantum nonlinear oscillators 101 are coupled, a term represented by the product of three spin matrices such as XᵢXⱼXₖ is added to the Hamiltonian in expression (9). Similarly, when four or more quantum nonlinear oscillators 101 are coupled, a matrix product term shown in expression (10) equivalent to the number of coupled quantum nonlinear oscillators 101 is added to expression (9).

The control unit 104 generates control signals that are input to all of the quantum nonlinear oscillators 101 and all of the second couplers 103. The control signals generated by the control unit 104 include at least a first control signal for controlling A(s) in expression (7), a second control signal for controlling B(s) in expression (7), and a third control signal for controlling C(s) in expression (9).

The control unit 104 may be configured using a semiconductor device that is placed at room temperature. Alternatively, the control unit 104 may be configured using a superconducting circuit cooled to an extremely low temperature of approximately several mK (milliKelvin) to several Kelvin.

The measurement device 105 measures the quantum state of each quantum nonlinear oscillator 101. As the measurement device 105, an existing measurement device capable of measuring quantum states can be used.

The measurement device 105 may be configured using a semiconductor device placed at room temperature. Alternatively, the measurement device 105 may be configured using a superconducting circuit cooled to an extremely low temperature of approximately several mK to several K.

The control unit 104 may control the measurement device 105 to measure the quantum state.

As described above, the calculation device 100 includes a quantum nonlinear oscillator composed of a plurality of quantum nonlinear oscillators 101. The calculation device 100 controls the quantum nonlinear oscillators 101 to generate one of two distinguishable quantum states. The calculation device 100 searches for a ground state among the quantum states generated by the plurality of quantum nonlinear oscillators 101. Furthermore, the plurality of quantum nonlinear oscillators 101 are coupled via the first couplers 102 and the second couplers 103, and the coupling strength can be changed.

The quantum nonlinear oscillators 101 are realized, for example, by a superconducting circuit using a superconducting material. When the quantum nonlinear oscillators 101 are realized by a superconducting circuit, the quantum nonlinear oscillator operates with being cooled to an extremely low temperature of approximately several mK. In this case, the quantum nonlinear oscillators 101 are cooled, for example, using a dilution refrigerator.

The total Hamiltonian of the quantum annealing executed by the calculation device 100 is expressed as the Hamiltonian H(s) in expression (11), which is the sum of the Hamiltonians H_{QNO}(S), Hᵢₙₜ₁ and Hᵢₙₜ₂(s) shown from expression (7) to expression (9).

$$\begin{matrix}[ Expression 11 ] & \\ H ( s ) := {\sum }_{i = 1}^{N} ( - A ( s ) {S}_{i}^{x} - B ( s ) {( {S}_{i}^{z} )}^{2} - {h}_{i} {S}_{i}^{z} ) - {\sum }_{i < j} {J}_{ij} {S}_{i}^{z} {S}_{j}^{z} + C ( s ) {\sum }_{i < j} {X}_{i} {X}_{j} & ( 11 )\end{matrix}$$

In the process in which the quantum nonlinear oscillators 101 generate the two distinguishable quantum states in response to an increase in the value of the control parameter s, the calculation device 100 is capable of adjusting the strength of the coupling by the second couplers 103 represented by C(s) in expression (9). In particular, by making C(s)>0, the quantum annealing based on the Hamiltonian in expression (11) becomes non-stoquastic. That is to say, by coupling the quantum nonlinear oscillators 101 to one another via the second couplers 103, quantum annealing using a non-stoquastic quantum mechanical bifurcation phenomenon can be executed.

According to the calculation device 100, in quantum annealing using a conventional quantum mechanical bifurcation phenomenon, when solving a combinatorial optimization problem in which a first-order phase transition occurs, the computation required can be shortened by avoiding a first-order phase transition by executing non-stoquastic quantum annealing, and adjusting C(s) such that the minimum energy gap during quantum annealing becomes larger.

Next, the operation of the calculation device 100 will be described. The control unit 104 increases the value of the control parameter s from 0 to 1 with the passage of time in the quantum annealing, generates the first control signal and the second control signal such that the quantum nonlinear oscillators 101 exhibit a quantum bifurcation phenomenon, and generates the third control signal for adjusting the strength of the coupling by the second couplers 103.

Then, the measurement device 105 measures the quantum state generated by each quantum nonlinear oscillator 101 at the completion of quantum annealing. As a result, the nature of the ground state of the Ising model represented by expression (1) can be known. In other words, the nature of the solution of a predetermined combinatorial optimization problem mapped to the Ising model represented by expression (1) can be known. In this way, it is possible to find the solution of the desired combinatorial optimization problem.

Next, using a theoretical model represented by expression (12), the results of theoretically verifying the effects of the present exemplary embodiment for a combinatorial optimization problem in which p Ising variables are correlated will be described.

$$\begin{matrix}[ Expression 12 ] & \\ H ( s ) = {\sum }_{i = 1}^{N} ( - A ( s ) {S}_{i}^{x} - B ( s ) {( {S}_{i}^{z} )}^{2} ) - {N ( \frac{1}{N} {\sum }_{i = 1}^{N} {S}_{i}^{z} )}^{p} + C ( s ) {N ( \frac{1}{N} {\sum }_{i = 1}^{N} {X}_{i} )}^{2} & ( 12 )\end{matrix}$$

In expression (12), “N(1/NΣᵢ₋₁^{N}Sᵢ^{z})^{p}” of the third term on the right side expresses that p quantum nonlinear oscillators 101 are coupled via the first couplers 102 according to the combinatorial optimization problem in which p Ising variables are correlated. The fourth term on the right side expresses that two quantum nonlinear oscillators 101 are coupled via the second couplers 103.

The optimal solution of the combinatorial optimization problem solved using the Hamiltonian H(s) in expression (12) is self-evident. When p is an even number, the optimal solution corresponds to a state in which all of the quantum nonlinear oscillators 101 generate the same quantum state. When p is an odd number, the optimal solution corresponds to a state in which all of the quantum nonlinear oscillators 101 generate the “|+1>” quantum state.

The Hamiltonian H(s) in expression (12) is obtained by setting hᵢ=0 in expression (11), replacing “Σi<j (JᵢⱼSᵢ^{z}Sⱼ^{z})” with “N(1/NΣᵢ₌₁^{N}Sᵢ^{z})^{p}”, and replacing “Σ_{i<j}XᵢXⱼ” with “N(1/Σᵢ₌₁^{N}Xᵢ)²”. The replacement of “Σi<j XᵢXⱼ” with “N(1/NΣᵢ₌₁^{N}Xᵢ)²” is for theoretical analysis. If the size N of the problem is sufficiently large, then “Σ_{i<j}XᵢXⱼ” and “N(1/NΣᵢ₌₁^{N}Xᵢ)²” are substantially equal.

It is known that in the Hamiltonian in expression (12), a first-order phase transition occurs during annealing when p is an integer greater than or equal to 3, C(s)=0, and the problem size N is sufficiently large. In this case, the combinatorial optimization problem expressed in expression (12) is a difficult problem for quantum annealing. The difficulty referred to here is that the time required to find the optimal solution increases exponentially as the size of the problem increases. It is known that when p in expression (12) approaches infinity, the difficulty cannot be resolved by any means.

Next, a method of setting C(s) so that a first-order phase transition does not occur during annealing will be described from a theoretical standpoint using the model of expression (12).

In the Hamiltonian in expression (12), each quantum nonlinear oscillator 101 is symmetrical with respect to the local bias and the coupling by the first couplers 102 and the second couplers 103. Therefore, in the instantaneous ground state for each value of the control parameter s in the Hamiltonian in expression (12), the quantum states generated by the respective quantum nonlinear oscillators 101 can all be the same state. Consequently, the quantum states generated as the instantaneous ground state by the respective quantum nonlinear oscillators 101 can be collectively described by a tensor product as represented by expression (13).

$$\begin{matrix}[ Expression 13 ] & \\ {{{\vert Ψ 〉 = {⊗}_{i = 1}^{N} ( cos \frac{θ}{2} \vert 0 〉}_{i} + sin \frac{θ}{2} cos \frac{ϕ}{2} {e}^{i α} \vert + 1 〉}_{i} + sin \frac{θ}{2} sin \frac{ϕ}{2} {e}^{i β} \vert - 1 〉}_{i} ) & ( 13 )\end{matrix}$$

“|Ψ>” represents a state that aggregates the quantum state of each quantum nonlinear oscillator 101. In expression (12), i is an index of each quantum nonlinear oscillator 101. The index i identifies the quantum nonlinear oscillators 101. “|0>ᵢ” represents the initial quantum state of the ith quantum nonlinear oscillator 101. “|+1>ᵢ” and “|−1>ᵢ” represent mutually distinguishable quantum states that can be generated by the ith quantum nonlinear oscillator 101 at the completion of annealing. “|+1>ᵢ” and “|−1>ᵢ” correspond to Ising variables +1 and −1, respectively.

Each of θ, φ, α, and β are parameters that determine the probability of measuring “|0>ᵢ”, “|+1>ᵢ”, and “|−1>ᵢ” in the quantum state generated by each quantum nonlinear oscillator 101 during quantum annealing. The values of θ, φ, α, and β all change according to the value of the control parameter s. Because the quantum states generated by the quantum nonlinear oscillators 101 are all the same in the instantaneous ground state, θ, φ, α, and β are set to the same values in all the quantum nonlinear oscillators 101.

The values of θ, φ, α, and β that give the instantaneous ground state in expression (13) can be determined by computing a semiclassical potential V given by expression (14).

$$\begin{matrix}[ Expression 14 ] & \\ V ( s , θ , ϕ , α , β ) := {lim}_{N \to ∞} \frac{〈 Ψ \vert H ( s ) \vert Ψ 〉}{N} = - \frac{A ( s )}{\sqrt{2}} sin θ ( cos \frac{ϕ}{2} cos α + sin \frac{ϕ}{2} cos β ) - B ( s ) {sin}^{2} \frac{θ}{2} + C ( s ) {( {sin}^{2} \frac{θ}{2} sin ϕ cos ( α - β ) )}^{2} - {( {sin}^{2} \frac{θ}{2} cos ϕ )}^{2} & ( 14 )\end{matrix}$$

By inputting the values of θ, φ, α, and β that minimize the semiclassical potential V given by expression (14) into expression (13) for each value of the control parameter s, the instantaneous ground state can be computed for each value of the control parameter s. In the theoretical analysis, the values of θ, φ, α, and β can be obtained by a numerical computation.

By using the values of θ, φ, α, and β that minimize the semiclassical potential V given by expression (14), a magnetization m (also referred to as an order variable) defined by expression (15) can be computed for each value of the control parameter s.

$$\begin{matrix}[ Expression 15 ] & \\ m := {lim}_{N \to ∞} 〈 Ψ \vert \frac{1}{N} {\sum }_{i = 1}^{N} {S}_{i}^{z} \vert Ψ 〉 = {sin}^{2} \frac{θ}{2} cos ϕ & ( 15 )\end{matrix}$$

The magnetization m computed in expression (15) represents the average quantum state generated by the quantum nonlinear oscillators 101. According to the magnetization m, the overall average state of the instantaneous ground state can be known for each value of the control parameter s. For example, when m=0, the quantum state generated by the quantum nonlinear oscillators 101 is, on average, the “|0>” state or a superposition state of “|+1>” and “|−1>”. When m=1, the quantum state generated by the quantum nonlinear oscillators 101 is, on average, the “|+1>” state. When m=−1, the quantum state generated by the quantum nonlinear oscillators 101 is, on average, the “|−1>” state.

The magnetization m is used as an order parameter in the phase transition of a magnetic material. The order variable referred to here is a macroscopic variable representing the order of the phase. During a phase transition, the value of the order parameter changes significantly.

The values of θ, φ, α, and β that minimize the semiclassical potential V given by expression (13) obtained by a numerical computation are input into expression (15) to compute the magnetization m for each value of the control parameter s. As a result, it is possible to know whether or not a first-order phase transition has occurred during annealing.

In the quantum annealing of the Hamiltonian in expression (12), m=0 at the start of annealing and m=1 at the completion of annealing. If the magnetization m changes discontinuously from m=0 to m=1 by the completion of annealing, it can be understood that a first-order phase transition has occurred. On the other hand, if the value of m changes continuously from m=0 to m=1, it can be understood that a second-order phase transition has occurred.

As mentioned above, it is known that a combinatorial optimization problem in which a first-order phase transition occurs during quantum annealing requires an exponential time to find the optimal solution. On the other hand, it is known that when a first-order phase transition does not occur and only a second-order phase transition occurs, the time required to find the optimal solution is determined by a power function. FIG. 7 is a diagram showing a first example of the relationship between the value of the control parameter s and the value of the magnetization m. FIG. 7 shows the magnetization m computed by expression (15) for the control parameter s when p=5 and C(s)=0. The vertical axis of the graph in FIG. 7 represents the magnetization m, and the horizontal axis represents the range of the control parameter s from 0.3 to 0.7. In the example of FIG. 7, the value of the magnetization m changes discontinuously near s=0.5. In this case, a discontinuous change in the magnetization m indicates that a first-order phase transition has occurred. Therefore, when C(s)=0, that is, when the quantum nonlinear oscillators 101 are not coupled via the second couplers 103, an exponential time is required to find the optimal solution.

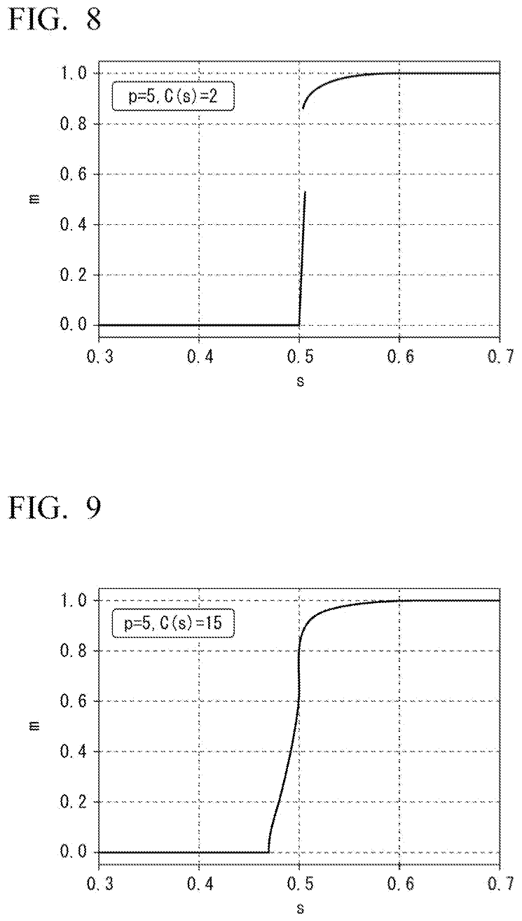

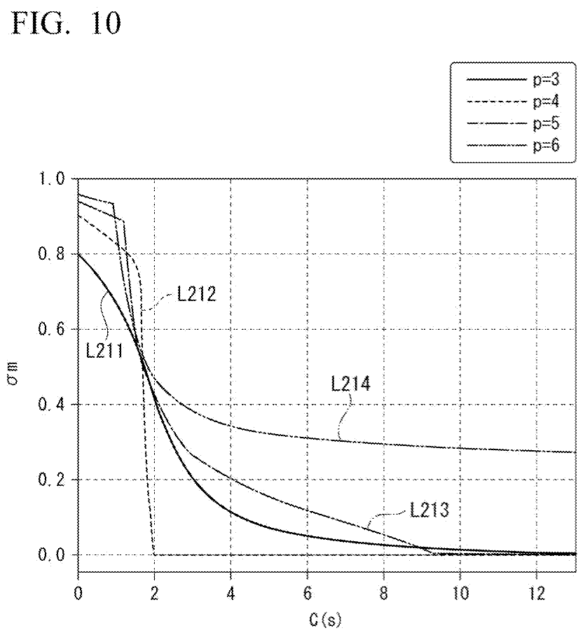

FIG. 8 is a diagram showing a second example of the relationship between the value of the control parameter s and the value of the magnetization m. FIG. 8 shows the magnetization m computed by expression (15) for the control parameter s when p=5 and C(s)=2. The vertical axis of the graph in FIG. 8 represents the magnetization m, and the horizontal axis represents the range of the control parameter s from 0.3 to 0.7.

In the example of FIG. 8, the value of the magnetization m continuously increases from 0 near s=0.5, and then changes discontinuously. A continuous change in the magnetization m in this case indicates that a second-order phase transition has occurred, and a discontinuous change in the magnetization m indicates that a first-order phase transition has occurred. Therefore, when C(s)=2, although the quantum nonlinear oscillators 101 are coupled via the second couplers 103, an exponential time is required to find the optimal solution.

FIG. 9 is a diagram showing a third example of the relationship between the value of the control parameter s and the value of the magnetization m. FIG. 9 shows the magnetization m computed by expression (15) for the control parameter s when p=5 and C(s)=15. The vertical axis of the graph in FIG. 9 represents the magnetization m, and the horizontal axis represents the range of the control parameter s from 0.3 to 0.7.

In the example of FIG. 9, the value of magnetization m continuously increases from 0 near s=0.5, and reaches m=1. In the example of FIG. 9, unlike the examples of FIG. 7 and FIG. 8, a first-order phase transition does not occur, but a second-order phase transition does occur.

Comparing the example of FIG. 9 with the example of FIG. 7 and the example of FIG. 8, by strengthening the coupling between the quantum nonlinear oscillators 101 via the second couplers 103, the optimal solution can be found in a time determined by a power function.

As shown in the examples of FIG. 7 to FIG. 9, increasing the strength of the coupling by the second couplers 103 reduces the width of discontinuous change. When the strength of the coupling by the second couplers 103 is further increased, the discontinuous change disappears.

In each of FIG. 8 and FIG. 9, there is a point at which the magnetization m starts to increase continuously from 0, and it is possible to precisely compute that the second-order phase transition occurs here. On the other hand, whether or not the first-order phase transition as illustrated in FIG. 7 and FIG. 8 occurs can be verified by a numerical computation.

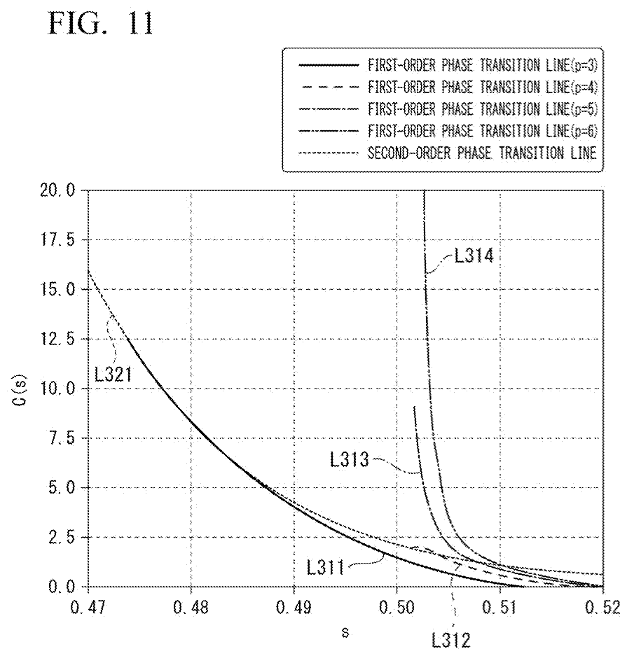

FIG. 10 is a diagram showing an example of the relationship between the coupling strength by the second couplers 103 and the discontinuous change width of the magnetization m. The vertical axis of the graph in FIG. 10 represents the discontinuous change width of the magnetization m during annealing, and the horizontal axis represents the coupling strength C(s) by the second couplers 103. FIG. 10 shows the calculation result of the discontinuous change width of the magnetization m at each coupling strength C(s) by the second couplers 103.

In the example of FIG. 10, the value of C(s) is a constant value that is independent of the control parameter s.

The line L211 represents the discontinuous change width of the magnetization m with respect to the strength C(s) by the second couplers 103 when p=3. The line L212 represents the discontinuous change width of the magnetization m with respect to the strength C(s) by the second couplers 103 when p=4. The line L213 represents the discontinuous change width of the magnetization m with respect to the strength C(s) by the second couplers 103 when p=5. The line L214 represents the discontinuous change width of the magnetization m with respect to the strength C(s) by the second couplers 103 when p=6.

In FIG. 10, when the discontinuous change width of the magnetization m is not 0 with respect to the set value of the intensity C(s) of the second couplers 103, this indicates that a first-order phase transition has occurred during quantum annealing. The discontinuous change width of the magnetization m at this time represents the strength of the first-order phase transition. It is known that even when a first-order phase transition occurs, the required computation time is relatively short if the discontinuous change width of the magnetization m is relatively small. In the example of FIG. 10, even when a first-order phase transition occurs, the discontinuous change width of the magnetization m becomes smaller for any value of p when the quantum nonlinear oscillators 101 are coupled to one another via the second couplers 103 than when they are not coupled. In this way, as a result of the second couplers 103 coupling the quantum nonlinear oscillators 101 to one another, the strength of the first-order phase transition can be mitigated.

For example, the discontinuous change width of the value of magnetization m in FIG. 8 is smaller than the discontinuous change width of the value of magnetization m in FIG. 7. In this way, in the example of FIG. 8, because the value of C(s), that is, the strength of the coupling of the quantum nonlinear oscillators 101 to one another via the second couplers 103, is increased compared to the case of FIG. 7, the first-order phase transition has been mitigated. In the example of FIG. 8, although a first-order phase transition occurs during annealing and an exponential time is required to find the optimal solution, by increasing the strength of the coupling of the quantum nonlinear oscillators 101 to one another via the second couplers 103 compared to the case of FIG. 7, the time required to find the optimal solution can be shortened.

In FIG. 10, when the discontinuous change width of the magnetization m is 0 with respect to the set value of the intensity C(s) of the second couplers, this indicates that a first-order phase transition has not occurred.

In FIG. 10, when the strength of the second couplers 103 is set to C(s)=0, that is to say, when the quantum nonlinear oscillators 101 are not coupled to one another via the second couplers 103, a first-order phase transition occurs such that the discontinuity width of the magnetization m exceeds 0.8 for any value of p. On the other hand, by increasing the strength of the coupling by the second coupler 103 to C(s)=10, when p=3, 4, or 5, the discontinuity width of the magnetization m can be substantially reduced to 0 and a second-order phase transition can be made to occur.

When p=6, the discontinuity width of the magnetization m cannot be substantially reduced to 0 with the strength of the coupling by the second couplers 103 within the range illustrated in FIG. 10. However, the discontinuity width of the magnetization m monotonically decreases by increasing the strength of the coupling of the second couplers 103. For this reason, when p=6, it is expected that the discontinuous change width of the magnetization m can be substantially reduced to 0 by further increasing the strength of the coupling by the second couplers 103.

FIG. 11 is a phase diagram illustrated based on the calculation result of a magnetization m using expression (15). The horizontal axis of the graph in FIG. 11 represents the value of the control parameter s, and the vertical axis represents the coupling strength C(s) by the second couplers 103. FIG. 11 illustrates values of the control parameter s in the range of 0.47 to 0.52.

The line L311 is a first-order phase transition line when p=3 in expression (11). The line L312 is a first-order phase transition line when p=4 in expression (11). The line L313 is a first-order phase transition line when p=5 in expression (11). The line L314 is a first-order phase transition line when p=6 in expression (11). The first-order phase transition lines can be illustrated by numerically calculating the magnetization m shown in expression (15). The magnetization changes discontinuously on the first-order phase transition line.

The line L321 is a second-order phase transition line. The second-order phase transition line can be illustrated by a rigorous computation.

In FIG. 11, in the process of changing the value of the control parameter s from 0 to 1, when the trajectory in FIG. 11, which has the value of the control parameter s and the coupling strength C(s) as coordinates, is set such that the coupling strength C(s) by the second couplers 103 intersects a first-order phase transition line, a first-order phase transition occurs and the time required for quantum annealing increases exponentially. In contrast, when C(s) is set in the present exemplary embodiment, C(s) should be set so that the trajectory in FIG. 11, which has the value of the control parameter s and the coupling strength C(s) as coordinates, avoids intersecting a first-order phase transition line. For example, when p=5, the coupling strength C(s) by the second couplers 103 may be set so that C(s)=10 near s=0.5. As a result, the trajectory in FIG. 11, which has the value of the control parameter s and the coupling strength C(s) as coordinates, can be prevented from intersecting a first-order phase transition line.

Even when the trajectory in FIG. 11, which has the value of the control parameter s and the coupling strength C(s) as coordinates, intersects a first-order phase transition line, the discontinuity width of the magnetization m shown in FIG. 10 is reduced and the difficulty is somewhat mitigated by setting C(s) to a positive value rather than setting C(s)=0. By setting the value of C(s) to a positive value, although the time required for quantum annealing increases exponentially, the degree of increase (the coefficient of the exponent) can be changed.

When illustrating FIG. 7, FIG. 8, FIG. 9, FIG. 10, and FIG. 11, A(s) in expression (12) has been set as a Gaussian function such as that shown in FIG. 4, and B(s) has been set as a linear function such as that shown in FIG. 5. However, as noted above, A(s) is not limited to a Gaussian function and B(s) is not limited to a linear function.

As a result of coupling the quantum nonlinear oscillators 101 to one another via the second couplers 103, it is possible to shorten the time required for computation of a combinatorial optimization problem. Specifically, when a first-order phase transition can be changed to a second-order phase transition by increasing the strength of the coupling by the second couplers 103, the time required to find the optimal solution by quantum annealing using a quantum mechanical bifurcation phenomenon can be shortened from time approximated by an exponential function to time approximated by a power function.

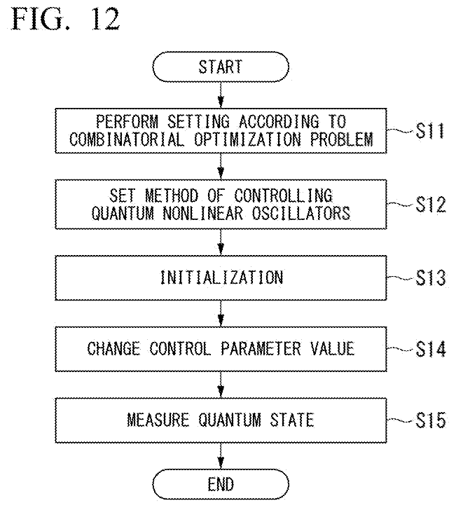

FIG. 12 is a flowchart showing an example of a processing procedure in a case where the calculation device 100 is used to solve a combinatorial optimization problem.

In the processing of FIG. 12, a user sets the local bias hᵢ of each quantum nonlinear oscillator 101 and the strength Jᵢⱼ of the coupling of the quantum nonlinear oscillators 101 to one another by the first couplers 102, according to the combinatorial optimization problem to be solved (step S11).

Then, the user sets the method of control by the control unit 104 of the quantum nonlinear oscillators 101 including the second couplers 103 (step S12). Specifically, the user sets the functions A(s), B(s) and C(s).

Next, the control unit 104 sets the control parameter s to an initial value of 0, and initializes the quantum state generated by each quantum nonlinear oscillator 101 to “|0>” (step S13).

Then, the control unit 104 adiabatically changes the control parameter s so that a bifurcation phenomenon occurs in each quantum nonlinear oscillator 101 (step S14).

Further, the measurement device 105 measures the quantum state generated by each quantum nonlinear oscillator 101 (step S15). This measurement provides a solution to the combinatorial optimization problem.

After step S15, the calculation device 100 ends the processing of FIG. 12.

As described above, each of the plurality of quantum nonlinear oscillators 101 change the quantum state from one quantum state to one of two quantum states, which differ from the one quantum state, or to a combined state of the two quantum states, according to a change in the control parameter. The first couplers 102 couple the quantum nonlinear oscillators 101 to one another at a coupling strength corresponding to the combinatorial optimization problem. The second couplers 103 couple the quantum nonlinear oscillators 101 to one another separately from the first couplers 102. The control unit 104 controls the control parameter of the quantum nonlinear oscillators and the coupling strength of the quantum nonlinear oscillators 101 to one another by the second couplers according to the passage of time. The measurement device 105 measures the quantum state represented by the quantum nonlinear oscillators.

As a result of the second couplers 103 coupling the quantum nonlinear oscillators 101 to one another separately from the first couplers 102, optimization problems such as those in which a first-order phase transition occurs during the quantum annealing process can be solved by executing quantum annealing in which the first-order phase transition is changed to a second-order phase transition. Alternatively, as a result of the second couplers 103 coupling the quantum nonlinear oscillator 101 to one another separately from the first couplers 102, the discontinuous change width of the magnetization at the time of a first-order phase transition can be made comparatively smaller when a first-order phase transition occurs during the quantum annealing process.

In this way, according to the calculation device 100, it is possible to shorten the execution time of quantum annealing.

Furthermore, according to the calculation device 100, because the plurality of quantum nonlinear oscillators 101 change the quantum state from one quantum state to one of two quantum states, which differ from the one quantum state, or to a combined state of the two quantum states, it is possible to execute quantum annealing using a quantum mechanical bifurcation phenomenon.

Moreover, the quantum nonlinear oscillators 101 adiabatically change the quantum state, which is initially set to one quantum state, according to a change in the control parameter. At the completion of computation of the combinatorial optimization problem, the quantum state is one of two quantum states, which differ from the one quantum state, or a combined state of the two quantum states.

According to the calculation device 100, it is expected that the optimal solution to a combinatorial optimization problem can be obtained in the respect that the quantum nonlinear oscillators 101 adiabatically change the quantum state.

In addition, the first couplers 102 couple the quantum nonlinear oscillators 101 to one another at a coupling strength corresponding to the coupling strength between Ising variables in the Hamiltonian of an Ising model representing the combinatorial optimization problem.

According to the calculation device 100, the combinatorial optimization problem can be reflected in the coupling strength of the first couplers 102. In this respect, it is expected that the combinatorial optimization problem can be solved with high precision.

Furthermore, the second couplers 103 couple the quantum nonlinear oscillators 101 to one another as an antiferromagnetic interaction of an operator that expresses a conversion of one of two distinguishable quantum states generated by the quantum nonlinear oscillators 101 into the other quantum state.

The calculation device 100 is expected to be able to execute quantum annealing using a non-stoquastic quantum bifurcation phenomenon. According to the calculation device 100, by executing quantum annealing using a non-stoquastic quantum bifurcation phenomenon, optimization problems such as those in which a first-order phase transition occurs during the quantum annealing process can be executed after substitution with quantum annealing in which a first-order phase transition has been changed to a second-order phase transition. Alternatively, according to the calculation device 100, by executing quantum annealing using a non-stoquastic quantum bifurcation phenomenon, the discontinuous change width of the magnetization at the time of a first-order phase transition can be made comparatively smaller when a first-order phase transition occurs during the quantum annealing process.

In this way, according to the calculation device 100, it is possible to shorten the execution time of quantum annealing.

Moreover, the control unit 104 controls the coupling strength of the quantum nonlinear oscillators 101 to one another by the second couplers 103 such that quantum annealing is executed using a non-stoquastic quantum bifurcation phenomenon.

The calculation device 100 is expected to be able to execute quantum annealing using a non-stoquastic quantum bifurcation phenomenon. According to the calculation device 100, by executing quantum annealing using a non-stoquastic quantum bifurcation phenomenon, it is possible to achieve a shortening of the execution time of quantum annealing as described above.

In addition, the control unit 104 controls the coupling strength of the quantum nonlinear oscillators 101 to one another by the second couplers 103 such that the trajectory of the coupling strength of the quantum nonlinear oscillators 101 to one another by the second couplers 103 does not intersect a first-order phase transition line upon changing the control parameter value.

According to the calculation device 100, by setting the coupling strength of the quantum nonlinear oscillators 101 to one another by the second couplers 103 to a coupling strength whose trajectory does not intersect a first-order phase transition line, optimization problems such as those in which a first-order phase transition occurs during the quantum annealing process can be executed after substitution with quantum annealing in which a first-order phase transition has been changed to a second-order phase transition.

In this way, according to the calculation device 100, it is possible to shorten the execution time of quantum annealing.

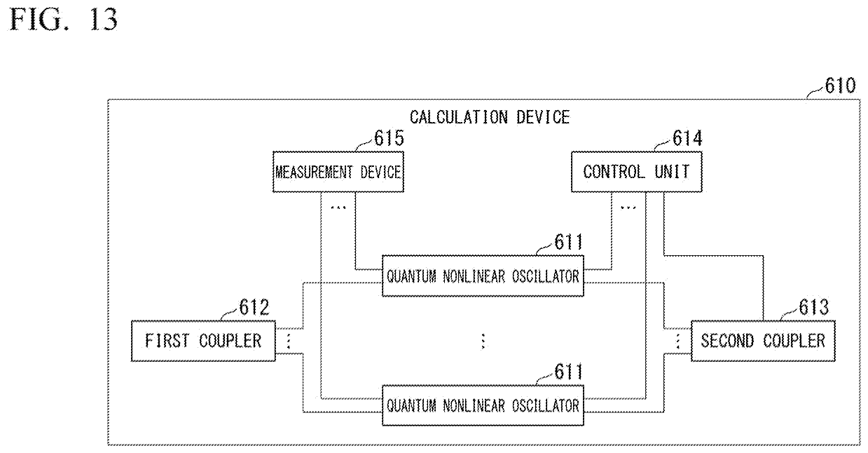

FIG. 13 is a diagram showing a second example of a configuration of a calculation device according to an exemplary embodiment. In the configuration shown in FIG. 13, a calculation device 610 includes a plurality of quantum nonlinear oscillators 611, a first coupler 612, a second coupler 613, a control unit 614, and a measurement device 615.

In the present configuration, each of the plurality of quantum nonlinear oscillators 611 change the quantum state from one quantum state to one of two quantum states, which differ from the one quantum state, or to a combined state of the two quantum states, according to a change in the control parameter. The first coupler 612 couples the quantum nonlinear oscillators 611 to one another at a coupling strength corresponding to the combinatorial optimization problem. The second coupler 613 couples the quantum nonlinear oscillators 611 to one another separately from the first coupler 612. The control unit 614 controls the control parameter of the quantum nonlinear oscillators 611 and the coupling strength of the quantum nonlinear oscillators 611 to one another by the second coupler 613 according to the passage of time. The measurement device 615 measures the quantum state represented by the quantum nonlinear oscillators 611.

The control unit 614 corresponds to an example of a control means.

As a result of the second coupler 613 coupling the quantum nonlinear oscillators 611 to one another separately from the first coupler 612, optimization problems such as those in which a first-order phase transition occurs during the quantum annealing process can be solved by executing quantum annealing in which a first-order phase transition is changed to a second-order phase transition. Alternatively, as a result of the second coupler 613 coupling the quantum nonlinear oscillators 611 to one another separately from the first coupler 612, the discontinuous change width of the magnetization at the time of a first-order phase transition can be made comparatively smaller when a first-order phase transition occurs during the quantum annealing process.

In this way, according to the calculation device 610, it is possible to shorten the execution time of quantum annealing.

Furthermore, according to the calculation device 610, because the plurality of quantum nonlinear oscillators 611 change the quantum state from one quantum state to one of two quantum states, which differ from the one quantum state, or to a combined state of the two quantum states, it is possible to execute quantum annealing using a quantum mechanical bifurcation phenomenon.

The quantum nonlinear oscillators 611 can be configured using, for example, the quantum nonlinear oscillators 101 and the like shown in FIG. 1. The first couplers 612 can be configured using, for example, the first couplers 102 and the like shown in FIG. 1. The second coupler 613 can be configured using, for example, the second couplers 103 and the like shown in FIG. 1. The control unit 614 can be implemented using the functions of the control unit 104 and the like in FIG. 1. The measurement device 615 can be configured using, for example, the measurement device 105 and the like shown in FIG. 1.

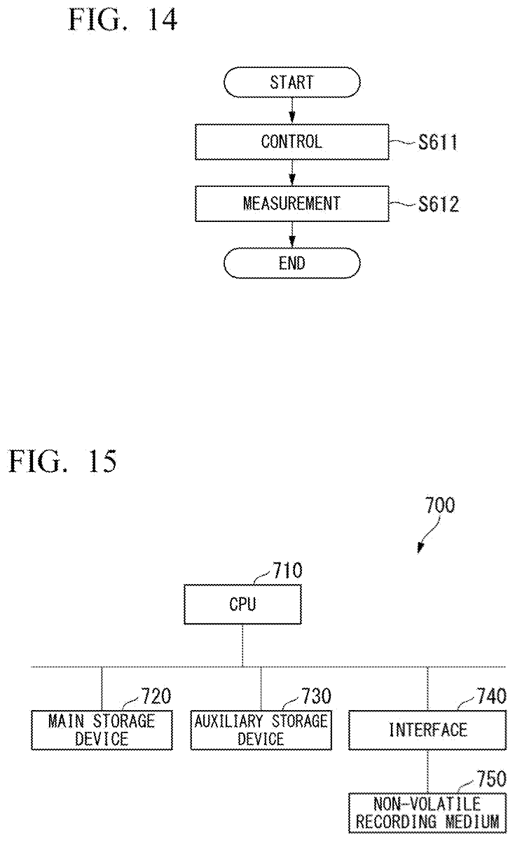

FIG. 14 is a diagram showing an example of the processing procedure of a calculation method according to an exemplary embodiment. The calculation method shown in FIG. 14 includes performing a control (step S611), and performing a measurement (step S612).

In performing a control (step S611), a computer that controls a calculation device in which a plurality of quantum nonlinear oscillators that change a quantum state from one quantum state to one of two quantum states, which differ from the one quantum state, or to a combined state of the two quantum states, according to a change in a control parameter value, are coupled to one another by a first coupler at a coupling strength corresponding to a combinatorial optimization problem, and the quantum nonlinear oscillators are further coupled to one another by a second coupler that is separate from the first coupler, controls, in response to a passage of time, the control parameter value of the quantum nonlinear oscillators and the coupling strength between the quantum nonlinear oscillators by the second coupler.

In performing a measurement (step S612), the computer described above measures the quantum state represented by the quantum nonlinear oscillators.

As a result of the second coupler 613 coupling the quantum nonlinear oscillators 611 to one another separately from the first coupler 612, by performing the control of step S611, optimization problems such as those in which a first-order phase transition occurs during the quantum annealing process can be solved by executing quantum annealing in which a first-order phase transition is changed to a second-order phase transition. Alternatively, as a result of the second coupler 613 coupling the quantum nonlinear oscillators 611 to one another separately from the first coupler 612, then by performing the control of step S611, the discontinuous change width of the magnetization at the time of a first-order phase transition can be made comparatively smaller when a first-order phase transition occurs during the quantum annealing process.

In this way, according to the calculation method shown in FIG. 14, it is possible to shorten the execution time of quantum annealing.

Furthermore, according to the calculation method shown in FIG. 14, because the plurality of quantum nonlinear oscillators change the quantum state from one quantum state to one of two quantum states, which differ from the one quantum state, or to a combined state of the two quantum states, it is possible to execute quantum annealing using a quantum mechanical bifurcation phenomenon.

FIG. 15 is a schematic block diagram showing a configuration of a computer according to at least one exemplary embodiment.

In the configuration shown in FIG. 15, a computer 700 includes a CPU 710, a main storage device 720, an auxiliary storage device 730, an interface 740, and a non-volatile recording medium 750.

Any one or more of the calculation devices 100 and 610, or a portion thereof, may be implemented by the computer 700. In this case, the operation of each of the processing units described above is stored in the auxiliary storage device 730 in the form of a program. The CPU 710 reads the program from the auxiliary storage device 730, expands the program in the main storage device 720, and executes the processing described above according to the program. Further, the CPU 710 reserves a storage area corresponding to each of the storage units in the main storage device 720 according to the program. The communication of each device with other devices is executed as a result of the interface 740 having a communication function and performing communication according to the control of the CPU 710. Furthermore, the interface 740 includes a port for the non-volatile recording medium 750, and reads information from the non-volatile recording medium 750 and writes information to the non-volatile recording medium 750.

When the calculation device 100 is implemented by the computer 700, the operation of the control unit 104 is stored in the auxiliary storage device 730 in the form of a program. The CPU 710 reads the program from the auxiliary storage device 730, expands the program in the main storage device 720, and executes the processing described above according to the program.

Furthermore, the CPU 710 reserves a storage area in the main storage device 720 for the control unit 104 to perform processing according to the program.

The communication between the calculation device 100 and other devices is executed as a result of the interface 740 including a communication function and operating under the control of the CPU 710.

The interactions between the calculation device 100 and the user is executed as a result of the interface 740 having an input device and an output device, presenting information to the user through the output device under the control of the CPU 710, and receiving user operations through the input device. The measurement of the quantum state performed by the calculation device 100 is executed as a result of the interface 740 including a measurement device and performing the measurement under the control of the CPU 710.

When the calculation device 610 is implemented by the computer 700, the operation of the control unit 614 is stored in the auxiliary storage device 730 in the form of a program. The CPU 710 reads the program from the auxiliary storage device 730, expands the program in the main storage device 720, and executes the processing described above according to the program.

Furthermore, the CPU 710 reserves a storage area in the main storage device 720 for the control unit 614 to perform processing according to the program.

The communication between the calculation device 610 and other devices is executed as a result of the interface 740 including a communication function and operating under the control of the CPU 710.

The interactions between the calculation device 610 and the user is executed as a result of the interface 740 having an input device and an output device, presenting information to the user through the output device under the control of the CPU 710, and receiving user operations through the input device. The measurement of the quantum state performed by the calculation device 610 is executed as a result of the interface 740 including a measurement device and performing the measurement under the control of the CPU 710.

One or more of the programs described above may be recorded in the non-volatile recording medium 750. In this case, the interface 740 may read out the program from the non-volatile recording medium 750. Then, the CPU 710 directly executes the program that has been read out by the interface 740, or executes the program after temporarily saving it in the main storage device 720 or the auxiliary storage device 730.

Furthermore, a program for executing some or all of the processing performed by the calculation devices 100 and 610 may be recorded in a computer-readable recording medium, and the processing of each unit may be performed by a computer system reading and executing the program recorded on the recording medium. The “computer system” referred to here is assumed to include an OS and hardware such as a peripheral device.

Moreover, the “computer-readable recording medium” refers to a portable medium such as a flexible disk, a magnetic optical disk, a ROM (Read Only Memory), or a CD-ROM (Compact Disc Read Only Memory), or a storage device such as a hard disk built into a computer system. Moreover, the program may be one capable of realizing some of the functions described above. Further, the functions described above may be realized in combination with a program already recorded in the computer system.

The exemplary embodiments of the present invention has been described in detail above with reference to the drawings. However, specific configurations are in no way limited to the exemplary embodiments, and include designs and the like within a scope not departing from the spirit of the present invention.

### INDUSTRIAL APPLICABILITY

The present invention may be applied to a calculation device, a calculation method, and a recording medium.

### DESCRIPTION OF REFERENCE SYMBOLS

100, 610 Calculation device
101, 611 Quantum nonlinear oscillator
102, 612 First coupler
103, 613 Second coupler
104, 614 Control unit
105, 615 Measurement device

What is claimed is:

1. A calculation device comprising:
a plurality of quantum nonlinear oscillators that change a quantum state from one quantum state to one of two quantum states, which differ from the one quantum state, or to a combined state of the two quantum states, according to a change in a control parameter value;
a first coupler that couples the quantum nonlinear oscillators to one another at a coupling strength corresponding to a combinatorial optimization problem;
a second coupler that couples the quantum nonlinear oscillators to one another separately from the first coupler;
a memory configured to store instructions;
a processor configured to execute the instructions to, in response to a passage of time, control the control parameter value of the quantum nonlinear oscillators and the coupling strength between the quantum nonlinear oscillators by the second coupler; and
a measurement device that measures the quantum state represented by the quantum nonlinear oscillators.

2. The calculation device according to claim 1, wherein the quantum nonlinear oscillators adiabatically change the quantum state that is initially set to the one quantum state according to the change in the control parameter to the one of the two quantum states, which differ from the one quantum state, or to the combined state of the two quantum states, at completion of computation of the combinatorial optimization problem.

3. The calculation device according to claim 1, wherein the first coupler couples the quantum nonlinear oscillators to one another at a coupling strength corresponding to a coupling strength between Ising variables in a Hamiltonian of an Ising model representing the combinatorial optimization problem.

4. The calculation device according to claim 1, wherein the second coupler couples the quantum nonlinear oscillators to one another as an antiferromagnetic interaction of an operator that expresses a conversion of one of two distinguishable quantum states generated by the quantum nonlinear oscillators into another quantum state.

5. The calculation device according to claim 4, wherein the processor is configured to execute the instructions to control the coupling strength of the quantum nonlinear oscillators to one another by the second coupler such that quantum annealing is executed using a non-stoquastic quantum bifurcation phenomenon.

6. The calculation device according to claim 1, wherein the processor is configured to execute the instructions to control the coupling strength of the quantum nonlinear oscillators to one another by the second coupler such that a trajectory of the coupling strength of the quantum nonlinear oscillators to one another by the second coupler due to the change in the control parameter value does not intersect a first-order phase transition line.

7. A calculation method executed by a computer that controls a calculation device in which a plurality of quantum nonlinear oscillators that change a quantum state from one quantum state to one of two quantum states, which differ from the one quantum state, or to a combined state of the two quantum states, according to a change in a control parameter value, are coupled to one another by a first coupler at a coupling strength corresponding to a combinatorial optimization problem, and the quantum nonlinear oscillators are further coupled to one another by a second coupler separately from the first coupler, comprising:
controlling, in response to a passage of time, the control parameter value of the quantum nonlinear oscillators and the coupling strength between the quantum nonlinear oscillators by the second coupler; and
measuring the quantum state represented by the quantum nonlinear oscillators.

8. A non-transitory recording medium that records a program for causing a computer that controls a calculation device in which a plurality of quantum nonlinear oscillators that change a quantum state from one quantum state to one of two quantum states, which differ from the one quantum state, or to a combined state of the two quantum states, according to a change in a control parameter value, are coupled to one another by a first coupler at a coupling strength corresponding to a combinatorial optimization problem, and the quantum nonlinear oscillators are further coupled to one another by a second coupler separately from the first coupler, to execute:
controlling, in response to a passage of time, the control parameter value of the quantum nonlinear oscillators and the coupling strength between the quantum nonlinear oscillators by the second coupler; and
measuring the quantum state represented by the quantum nonlinear oscillators.
